(19) United States
(12) Patent Application Publication
(10) Pub. No.: US 2011/0043782 A1
(43) Pub. Date: Feb. 24, 2011

(54) SPECTRAL PURITY FILTERS FOR USE IN A LITHOGRAPHIC APPARATUS

(75) Inventors: Wouter Anthon Soer, Nijmegen (NL); Vadim Yevgenyevich Banine, Deurne (NL); Maarten Marinus Johannes Wilhelmus Van Herpen, Heesch (NL); Andrei Mikhailovich Yakunin, Eindhoven (NL); Martin Jacobus Johan Jak, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/860,603

(22) Filed: Aug. 20, 2010

Related U.S. Application Data
(60) Provisional application No. 61/235,818, filed on Aug. 21, 2009.

(51) Int. Cl. G03B 27/72; F21V 9/06

(52) U.S. Cl. 355/71; 359/359

(57) ABSTRACT

A spectral purity filter includes a plurality of apertures extending through a member. The apertures are arranged to suppress radiation having a first wavelength and to allow at least a portion of radiation having a second wavelength to be transmitted through the apertures. The second wavelength of radiation is shorter than the first wavelength of radiation, A first region of the spectral purity filter has a first configuration that results in a first radiation transmission profile for the radiation having the first wavelength and the radiation having the second wavelength, and a second region of the spectral purity filter has a second, different configuration that results in a second, different radiation transmission profile for the radiation having the first wavelength and the radiation having the second wavelength.

### CROSS-REFERENCE TO RELATED APPLICATIONS

This application claims the benefit of priority from U.S. Provisional Patent Application Ser. No. 61/235,818, filed Aug. 21, 2009, the content of which is incorporated herein by reference its entirety.

### FIELD

The present invention relates to spectral purity filters (SPFs), and in particular, although not restricted to, spectral purity filters for use in a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (e.g. resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to be able to project ever smaller structures onto substrates, it has been proposed to use extreme ultraviolet radiation (EUV) having a wavelength within the range of 5-20 nm, for example within the range of 13-14 nm or 6-7 nm.

Extreme ultraviolet radiation (amongst, for example, other wavelengths of radiation) may be produced using, for example, a plasma. The plasma may be created for example by directing a laser at particles of a suitable material (e.g. tin), by directing a laser at a stream of a suitable gas or vapor such as Xe gas or Li vapor, or by creating an electrical discharge. The resulting plasma emits extreme ultraviolet radiation (or beyond EUV radiation), which is collected using a collector such as a mirrored normal incidence collector or a mirrored grazing incidence collector, which receives the extreme ultraviolet radiation and focuses the radiation into a beam.

Practical EUV Sources, such those which generate EUV radiation using a plasma, do not only emit desired ‘in-band’ EUV radiation, but also undesirable ‘out-of-band’ radiation. This out-of-band radiation is most notably in the deep ultra violet (DUV) radiation range (100-400 nm). Moreover, in the case of some EUV sources, for example laser produced plasma EUV sources, the radiation from the laser, usually at 10.6 μm, presents a significant amount of out-of-band radiation.

In a lithographic apparatus, spectral purity is desired for several reasons. One reason is that resist is sensitive to out-of-band wavelengths of radiation, and thus the image quality of patterns applied to the resist may be deteriorated if the resist is exposed to such out-of-band radiation. Furthermore, out-of-band radiation infrared radiation, for example the 10.6 μm radiation in some laser produced plasma sources, may lead to unwanted and unnecessary heating of the patterning device, substrate and optics within the lithographic apparatus. Such heating may lead to damage of these elements, degradation in their lifetime, and/or defects or distortions in patterns projected onto and applied to a resist-coated substrate.

In order to overcome these potential problems, several different transmissive spectral purity filters have been proposed which substantially prevent the transmission of infrared radiation, whilst simultaneously allowing the transmission of EUV radiation. Some of these proposed spectral purity filters comprise a thin metal layer or foil which is substantially opaque to, for example, infrared radiation, while at the same time being substantially transparent to EUV radiation. These and other spectral purity filters may also be provided with one or more apertures. The size and spacing of the apertures may be chosen such that infrared radiation is diffracted by the apertures (and thereby suppressed), while EUV radiation is transmitted through the apertures. A spectral purity filter provided with apertures may have a higher EUV transmittance than a spectral purity filter which is not provided with apertures. This is because EUV radiation will be able to pass through an aperture more easily than it would through a given thickness of metal foil or the like.

In a lithographic apparatus it is desirable to minimize the losses in intensity of radiation which is being used to apply a pattern to a resist coated substrate. One reason for this is that, ideally, as much radiation as possible should be available for applying a pattern to a substrate, for instance to reduce the exposure time and increase throughput. At the same time, it is desirable to minimize the amount of undesirable (e.g. out-of-band) radiation that is passing through the lithographic apparatus and which is incident upon the substrate.

### SUMMARY

It is an aspect of the present invention to provide an improved or alternative spectral purity filter. The spectral purity filter is configured to suppress radiation having a first wavelength (for example, undesirable radiation, such as infrared radiation), while at the same time allowing the transmission of radiation having a second wavelength (for example, desirable radiation, such as EUV radiation that is used to apply pattern to a resist coated substrate). Desirably, the spectral purity filter is arranged to transmit more radiation having a second wavelength in comparison with prior art spectral purity filters.

According to an aspect of the present invention there is provided a spectral purity filter, comprising: a plurality of apertures extending through a member, the apertures being arranged to suppress radiation having a first wavelength and to allow at least a portion of radiation having a second wavelength to be transmitted through the apertures, the second wavelength of radiation being shorter than the first wavelength of radiation, wherein a first region of the spectral purity filter has a first configuration that results in a first radiation transmission profile for the radiation having the first wavelength and the radiation having the second wavelength, and a second region of the spectral purity filter has a second, different configuration that results in a second, different radiation transmission profile for the radiation having the first wavelength and the radiation having the second wavelength.

A location or a dimension of the first region of the spectral purity filter, and/or a location or a dimension of the second region of the spectral purity filter may be related to at least one of: an angle of incidence of at least a part of a beam of radiation comprising radiation having the first wavelength and/or the radiation having the second wavelength that, in use, is to be incident upon the spectral purity filter; and/or an intensity distribution of at least a part of a beam of radiation comprising the radiation having the first wavelength and/or the radiation having the second wavelength that, in use, is to be incident upon the spectral purity filter.

The first region of the spectral purity filter having the first configuration may be an inner region of the spectral purity filter, and wherein the second region of the spectral purity filter having the second configuration may be an outer region of the spectral purity filter.

The first region of the spectral purity filter having the first configuration may be a region of the spectral purity filter onto which, in use a radiation beam is to be centred, and wherein the second region of the spectral purity filter having the second configuration may be a region of the spectral purity filter that surrounds the first region.

The first configuration and/or second configuration may be related to at least one of: an angle of incidence of at least a part of a beam of radiation comprising radiation having the first wavelength and/or the radiation having the second wavelength that, in use, is to be incident upon the spectral purity filter; and/or an intensity distribution of at least a part of a beam of radiation comprising the radiation having the first wavelength and/or the radiation having the second wavelength that, in use, is to be incident upon the spectral purity filter.

The first configuration, and/or the second configuration may be one or more of: a shape of one or more apertures; a diameter of one or more apertures; a space between one or more apertures; a depth of one or more apertures; a degree of tapering of one or more apertures; an angle of inclination of one or more apertures; a position of one or more apertures; a thickness or depth of the spectral purity filter; and/or a material of the spectral purity filter.

The difference between the first configuration and the second configuration is one or more of: a difference in a shape of one or more apertures; a difference in a diameter of one or more apertures; a difference in a depth of one or more apertures; a difference in spacing between one or more apertures; a difference in a degree of tapering of one or more apertures; a difference in an angle of inclination of one or more apertures; a difference in a position of one or more apertures; a difference in a thickness or depth of the spectral purity filter; and/or a difference in a material of the spectral purity filter.

The first region of the spectral purity filter may have a greater depth or thickness than the second region of the spectral purity filter.

The second region of the spectral purity filter may have apertures of a greater diameter than apertures in the first region of the spectral purity filter.

The difference between the first radiation transmission profile and the second transmission profile may be related to an amount of radiation of the first and/or second wavelength that is transmitted through the first and/or second region of the spectral purity filter.

The first region of the spectral purity filter may be formed integrally with the second region of the spectral purity filter.

The first region of the spectral purity filter may be formed separately from the second region of the spectral purity filter.

The first wavelength of radiation may have a wavelength that is in the infrared region of the electromagnetic spectrum. The second wavelength of radiation may have a wavelength that is substantially equal to or shorter than radiation having a wavelength in the EUV part of the electromagnetic spectrum.

According to an aspect of the present invention there is provided a lithographic apparatus or a radiation source having the spectral purity filter according to embodiments of the present invention.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 is a more detailed but schematic depiction of the lithographic apparatus shown in FIG. 1;

FIG. 3 schematically depicts a transmissive spectral purity filter;

FIG. 4 schematically depicts a side-on and part-section view of the spectral purity filter of FIG. 3, together with radiation incident on the filter in a direction perpendicular to a plane defined by the spectral purity filter;

FIG. 5 schematically depicts a side-on and part-section view of the spectral purity filter of FIG. 3 together with radiation incident on the filter in a direction that is not perpendicular to a plane defined by the spectral purity filter;

FIG. 6 schematically depicts a side-on and part-section view of half of a spectral purity filter according to an embodiment of the present invention, the spectral purity filter comprising a first region having a first configuration, and a second region having a second, different configuration;

FIG. 7 schematically depicts a spectral purity filter according to an embodiment of the present invention, the spectral purity filter comprising a first region having a first configuration, and a second region having a second, different configuration;

FIG. 8 schematically depicts a spectral purity filter according to an embodiment of the present invention, the spectral purity filter comprising a first region having a first configuration, and a second region having a second, different configuration; and

FIG. 9 is a more detailed view of a portion of the spectral purity filter of FIG. 8.

### DETAILED DESCRIPTION

FIG. 1 schematically depicts a lithographic apparatus 2 according to an embodiment of the invention. The apparatus 2 comprises an illumination system (illuminator) IL configured to condition a radiation beam B (e.g. EUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus 2, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

Examples of patterning devices include masks and programmable mirror arrays. Masks are well known in lithography, and typically in a EUV radiation (or beyond EUV) lithographic apparatus would be reflective. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system. Usually, in a EUV (or beyond EUV) radiation lithographic apparatus the optical elements will be reflective. However, other types of optical element may be used. The optical elements may be in a vacuum. Any use of the term “projection lens” herein may be considered as synonymous with the more general term “projection system”.

As here depicted, the apparatus 2 is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source and the lithographic apparatus may be separate entities. In such cases, the source is not considered to form part of the lithographic apparatus and the radiation beam is passed from the source SO to the illuminator IL with the aid of a beam delivery system comprising, for example, suitable directing mirrors and/or a beam expander. In other cases the source may be an integral part of the lithographic apparatus. The source SO and the illuminator IL, together with the beam delivery system if required, may be referred to as a radiation system.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator and a condenser. The illuminator IL may be used to condition the radiation beam B to have a desired uniformity and intensity distribution in its cross-section.

The radiation beam B is incident on the patterning device (e.g., mask MA), which is held on the support structure (e.g., mask table MT), and is patterned by the patterning device. Having been reflected by the mask MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus 2 could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes a programmable patterning device, such as a programmable mirror array of a type as referred to above.

Combinations and/or variations on the above described modes of use or entirely different modes of use may also be employed.

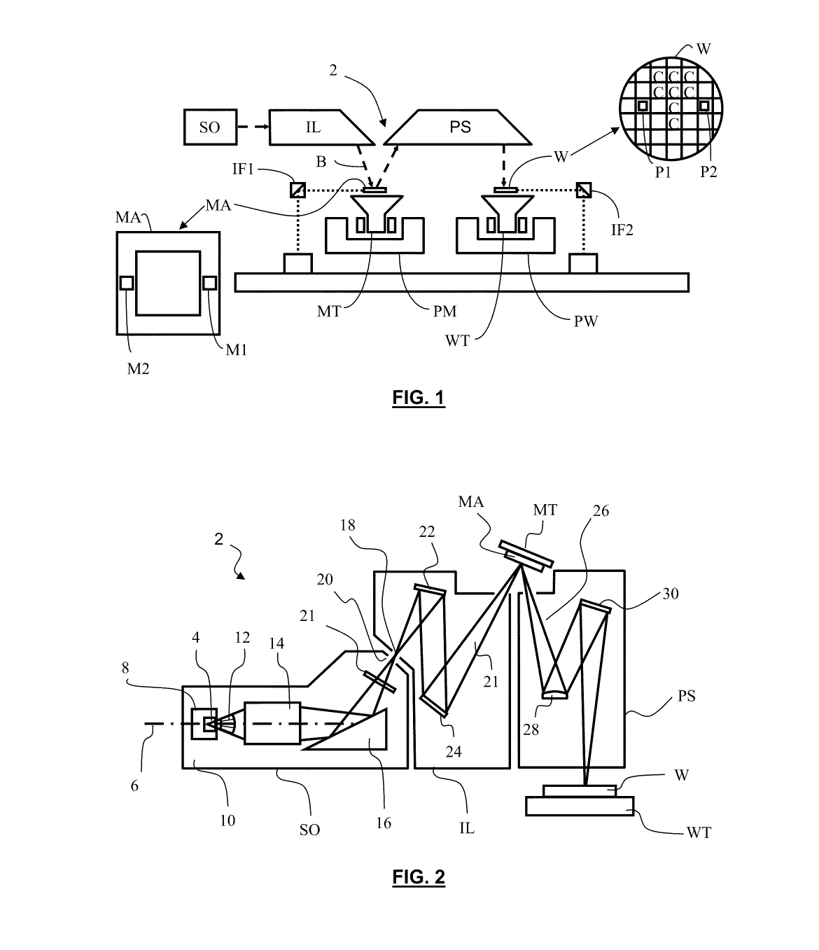

FIG. 2 shows the lithographic apparatus 2 in more detail, including a radiation source SO, an illuminator IL (sometimes referred to as an illumination system), and the projection system PS. The radiation source SO includes a radiation emitter 4 which may comprise a discharge plasma. EUV radiation may be produced by a gas or vapor, such as Xe gas or Li vapor in which very hot plasma is created to emit radiation in the EUV radiation range of the electromagnetic spectrum. The very hot plasma is created by causing partially ionized plasma of an electrical discharge to collapse onto an optical axis 6. Partial pressures of e.g. 10 Pa of Xe or Li vapor or any other suitable gas or vapor may be required for efficient generation of the radiation. In some embodiments, tin may be used. FIG. 2 illustrates a discharge produced plasma (DPP) radiation source SO. It will be appreciated that other sources may be used, such as for example a laser produced plasma (LPP) radiation source.

The radiation emitted by radiation emitter 4 is passed from a source chamber 8 into a collector chamber 10. The collector chamber 10 includes a contamination trap 12 and grazing incidence collector 14 (shown schematically as a rectangle). Radiation allowed to pass through the collector 14 is reflected off a grating spectral filter 16 to be focused in a virtual source point 18 at an aperture 20 in the collector chamber 10. Before passing through the aperture 20, the radiation passes through a spectral purity filter 21. Different embodiments of a spectral purity filter 21 are described in more detail below. From collector chamber 10, a beam of radiation 21 is reflected in the illuminator IL via first and second reflectors 22, 24 onto a reticle or mask MA positioned on reticule or mask table MT. A patterned beam of radiation 26 is formed which is imaged in projection system PS via first and second reflective elements 28, 30 onto a substrate W held on a substrate table WT.

It will be appreciated that more or fewer elements than shown in FIG. 2 may generally be present in the source SO, illumination system IL, and projection system PS. For instance, in some embodiments the illumination system IL and/or projection system PS may contain a greater or lesser number of reflective elements or reflectors.

It is known to use a spectral purity filter in a lithographic apparatus to filter out undesirable (e.g. out-of-band) wavelength components of a radiation beam. For instance, it is known to provide a spectral purity filter comprising one or more apertures. The diameter of each aperture is chosen such that the aperture suppresses one or more undesirable wavelengths of radiation (i.e. radiation having a first wavelength) by diffraction or scattering or the like, while allowing one or more desirable wavelengths of radiation (i.e. radiation having a second wavelength) to pass through the apertures. For instance, the undesirable radiation may comprise infrared radiation, whereas the desirable radiation may comprise EUV or beyond EUV radiation.

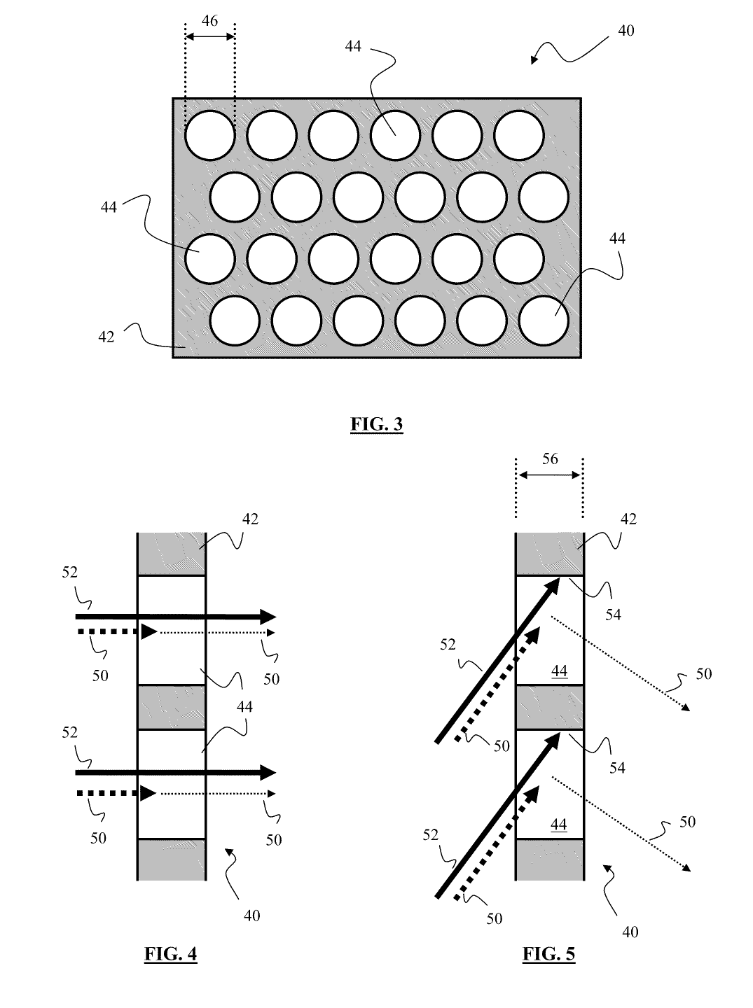

FIG. 3 schematically depicts a known (i.e. prior art) spectral purity filter 40. The spectral purity filter 40 comprises a plate 42 in which a periodic array of circular apertures 44 is provided. The diameter 46 of the apertures 44 is selected such that a first wavelength of radiation to be suppressed is substantially diffracted at the entrance of each aperture 44, while radiation of a second, shorter wavelength is transmitted through the apertures 44. The diameter 46 of the apertures 44 may be, for example, in the range of 1-100 μm, in order to suppress by diffraction radiation having a comparable wavelength.

The plate 42 can be formed from any suitable material. A foil or membrane may be used instead of, or in addition to, the plate 42. The plate 42 (or whichever structure is used) may be substantially opaque to the first wavelength of radiation or range of wavelengths which the spectral purity filter 40 is designed to suppress. For instance, the plate 42 may reflect or absorb the first wavelength, for example a wavelength in the infrared range of the electromagnetic spectrum. The plate 42 may also be substantially opaque to one or more second wavelengths of radiation which the spectral purity filter 40 is designed to transmit, for example a wavelength in the EUV range of the electromagnetic spectrum. However, the spectral purity filter 40 can also be formed from a plate 42 which is substantially transparent to the one or more first wavelengths that the spectral purity filter 40 is designed to transmit. This may increase the transmittance of the spectral purity filter 40 with respect to the one or more wavelengths which the spectral purity filter 40 is designed to transmit. An example of a material which may form the plate 42 of the spectral purity filter 40 is a metal. Another example is a thin foil that is substantially transparent to EUV radiation.

The apertures 44 in the spectral purity filter 40 are arranged in a hexagonal pattern. This arrangement may be preferred, since it gives the closest packing of circular apertures, and therefore the highest transmittance for the spectral purity filter 40. However, other arrangements of the apertures are also possible, for example square, and rectangular or other periodic or aperiodic arrangements may be used. For instance, in the case of an aperiodic array, a random pattern may be employed. The apertures (in whatever arrangement) may be circular in shape, or, for example, elliptical, hexagonal, square, rectangular, or any other suitable shape.

FIG. 4 schematically depicts the spectral purity filter 40 of FIG. 3 in a side-on and part-section view. The plate 42 in which the apertures 44 are provided is substantially planar in shape, and thus defines a plane. The apertures 44 extend through the spectral purity filter 40 in a direction that is substantially perpendicular to the plane defined by the plate 42 (i.e. apertures 44 each have a central axis that is perpendicular to a plane defined by the spectral purity filter 40).

FIG. 4 further depicts radiation having a first wavelength 50 and radiation having a second wavelength 52. The radiation 50, 52 constitutes radiation from a beam of radiation. When the radiation having a first wavelength 50 and radiation having a second wavelength 52 is incident upon the spectral purity filter 40 in a direction which is substantially perpendicular to a plane defined by the spectral purity filter 40, the radiation having a first wavelength 50 is diffracted by the apertures 44 and is substantially suppressed from being transmitted through the spectral purity filter 40. Only a small percentage of radiation having a first wavelength 50 is transmitted through the apertures 44. Radiation having a second wavelength 52 readily passes through the apertures 44 of the spectral purity filter 40. This is because the radiation having a second wavelength 52 is not substantially diffracted and suppressed by the apertures 44. However, this may not be the case if the radiation having a second wavelength 52 (and, for example, a radiation beam comprising radiation having a second wavelength) is incident on the spectral purity filter at an angle that is not perpendicular to a plane defined by the spectral purity filter 40.

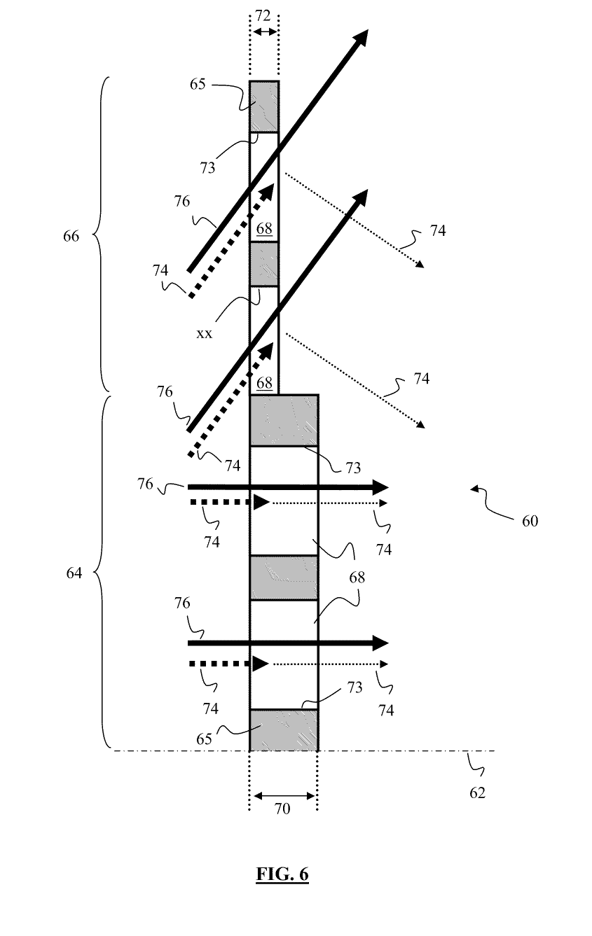

FIG. 5 schematically depicts the same side-on and part-section view of the spectral purity filter 40 shown in and described with reference to FIG. 4. In contrast to FIG. 4, however, in FIG. 5 radiation 50, 52 that is directed towards the spectral purity filter 40 is not directed in a direction which is substantially perpendicular (i.e. normal to) the plane defined by the spectral purity filter 40. Instead, radiation 50, 52 shown in FIG. 5 is incident on the spectral purity filter at an angle that is not perpendicular to a plane defined by the spectral purity filter 40. When the radiation 50, 52 is incident upon the spectral purity filter 40, the radiation having a first wavelength 50 is diffracted by the apertures 44 and is substantially suppressed from being transmitted through the spectral purity filter 40. Only a small percentage of radiation having a first wavelength 50 is transmitted through the apertures 44, and this percentage is substantially independent of the angle of incidence of the radiation having the first wavelength. In contrast, radiation having a second, shorter wavelength 50 does not pass through the apertures 44 of the spectral purity filter 40. This is because the radiation having the second wavelength 52 is incident upon and then absorbed or scattered by sidewalls 54 of the apertures 44.

From a review of FIGS. 4 and 5, and the description of those Figures, it may be appreciated that the transmission profile of the spectral purity filter 40 is dependent on, for example, the configuration of the spectral purity filter 40. For instance, the configuration may be: a shape of one or more apertures of the spectral purity filter, a diameter of one or more apertures, a depth of one or more apertures, a space between one or more apertures, a degree of tapering of one or more apertures, an angle of inclination of one or more apertures (i.e. the angle at which the aperture extends through the spectral purity filter with respect to a normal of a plane defined by that spectral purity filter), a position of one or more apertures (e.g. the location, distribution, spacing, or density of apertures), a thickness or depth of a spectral purity filter, and/or a material of a spectral purity filter (for example a material that is transmissive or opaque to, for example, radiation having the first or second wavelength).

In one example, if the diameters of all apertures within the spectral purity filter were increased, more radiation having the second wavelength may be transmitted through the spectral purity filter. However, the diffraction and the suppression of radiation having the first wavelength of radiation may be reduced. While it is desirable to increase the amount of radiation having the second wavelength (e.g. desirable radiation, such as EUV radiation), it is at the same time desirable to maintain the suppression of the transmission of radiation having the first wavelength (e.g. undesirable radiation, such as infrared radiation) below, or at a certain level. For instance, it may be desirable to ensure that only 1%, 2%, 3%, 4%, 5% or less than 5% of radiation having the first wavelength and which is incident on the spectral purity filter is transmitted through the spectral purity filter, while at the same time attempting to maximize the transmission of radiation having the second wavelength. This balance between the transmission of radiation having a first or second wavelength is further complicated if, for example, a radiation beam comprising radiation having a first and second wavelength of radiation has an intensity distribution which differs for the radiation having the first wavelength and the radiation having the second wavelength. Another complication might be a dependence on an angle of incidence of the transmission of radiation having the first wavelength or the second wavelength through the spectral purity filter. It is difficult to achieve such a balance, as well as taking into account the additional complications, with a spectral purity filter in which the apertures are uniformly distributed across the spectral purity filter or, more generally, for which the spectral purity filter has a single configuration for parts of the spectral purity filter onto which radiation is incident.

One or more problems of the prior art spectral purity filters may be obviated or mitigated using a spectral purity filter according to an embodiment of the present invention. According to an embodiment of the present invention, a spectral purity filter is provided which comprises apertures extending through the spectral purity filter. Each aperture is arranged to suppress radiation having a first wavelength (e.g. by diffraction), and to allow at least a portion of radiation having a second wavelength through the aperture, the second wavelength of radiation being shorter than the first wavelength of radiation. For example, the first wavelength of radiation may be undesirable radiation, such as infrared radiation, which is suppressed by diffraction, scattering or absorption at the opening of, or within the aperture. The second wavelength of radiation may be, for example, desirable radiation, such as EUV radiation which may be used to apply patterns to a resist-coated substrate. In contrast to existing spectral purity filters, the spectral purity filter of an embodiment of the present invention comprises of multiple regions (e.g. at least a first region and a second region). The regions of the spectral purity filter may be integrally formed with one another, or be separately formed and then joined together at a later stage in a manufacturing process of the spectral purity filter.

A first region of the spectral purity filter has a first configuration that results in a first radiation transmission profile for the radiation having the first wavelength and the radiation having the second wavelength. A second region of the spectral purity filter has a second, different configuration that results in a second, different radiation transmission profile for the radiation having the first wavelength and the radiation having the second wavelength. By appropriate selection of the size and/or location of the regions, and the configurations of those regions, this allows for a greater degree of control of the transmission profile of the spectral purity filter as a whole.

Because the spectral purity filter comprises multiple regions having different configurations, the resulting spectral purity filter is more versatile. For example, a location or a dimension (e.g. an extent, shape or area) of the first region of the spectral purity filter, and/or a location or a dimension (e.g. an extent, shape or area) of the second region of the spectral purity filter, and/or the first and second configurations of those first and second regions, may be related to one or more of: an angle of incidence of at least a part of a beam of radiation comprising radiation having the first wavelength and/or radiation having the second wavelength that, in use, is to be incident upon the spectral purity filter; and/or an intensity distribution of at least a part of a beam of radiation comprising radiation having the first wavelength and/or radiation having the second wavelength that, in use, is to be incident upon the spectral purity filter.

The configurations (or differences in those configurations) may be one or more of: a shape of one or more apertures of the spectral purity filter, a diameter of one or more apertures, a depth of one or more apertures, a space between one or more apertures a degree of tapering of one or more apertures, an angle of inclination of one or more apertures (i.e. the angle at which the aperture extends through the spectral purity filter with respect to a normal of a plane defined by that spectral purity filter), a position of one or more apertures (e.g. the location, distribution, spacing, or density of apertures), a thickness or depth of a spectral purity filter, and/or a material of a spectral purity filter (for example a material that is transmissive or opaque to, for example, radiation having the first or second wavelength).

The different regions, and the associated different configurations, may be constructed so as to increase the transmission of radiation having a second wavelength (e.g. the desirable radiation, such as EUV radiation) in comparison with prior art spectral purity filters, while still suppressing radiation having a first wavelength (e.g. undesirable radiation, such as infrared radiation) within or below required limits.

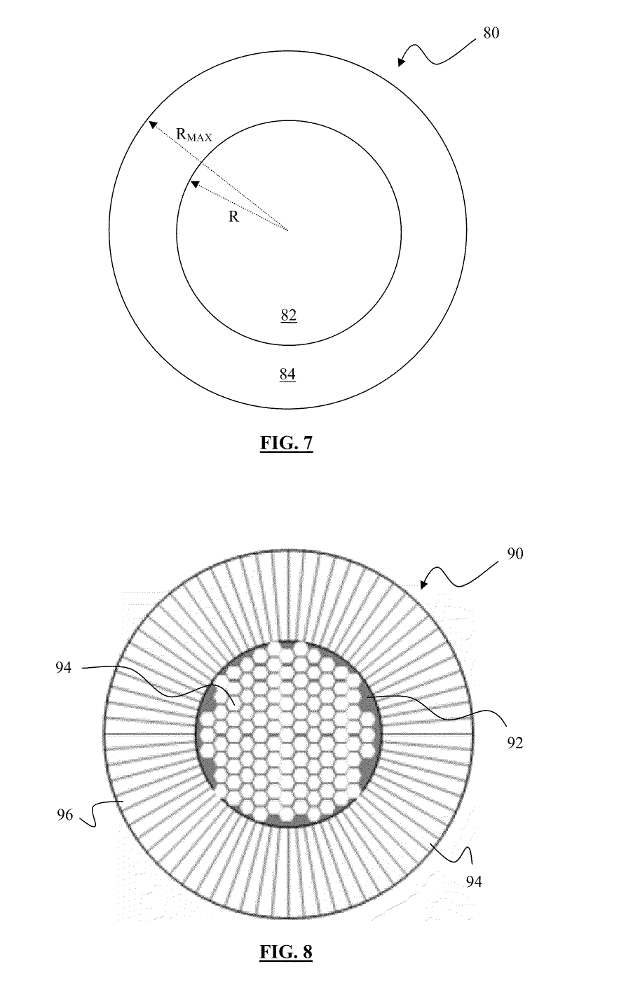

Specific embodiments of the present invention will now be described, by way of example only, with reference to FIGS. 6-8.

FIG. 6 schematically depicts a part of a spectral purity filter 60 according to an embodiment of the present invention. More specifically, FIG. 6 schematically depicts a side-on and part-section view of a top half of the spectral purity filter 60 (i.e. the half of the spectral purity filter 60 above a centerline 62 of the spectral purity filter 60).

The spectral purity filter 60 comprises a first region 64 and a second region 66. The first region 64 and second region 66 may be integrally formed, or may be separately formed and then attached to one another during, for example, a manufacturing process of the spectral purity filter 60. The regions 64, 66 may be formed from one or more planar members 65, which may be plates, membranes or foils. The planar members 65 may be, for example, opaque to radiation having a first wavelength (e.g. infrared radiation). Alternatively or additionally, the planar members 65 may be, for example, substantially transmissive to radiation having a second wavelength (e.g. infrared radiation).

The first region 64 is an inner region of the spectral purity filter 60, and the second region 66 is an outer region of the spectral purity filter 60. The inner region 64 is centered on and surrounds the centerline 62 of the spectral purity filter 60. The second region 66 surrounds the first region 64. Alternatively, or additionally, the first region 64 may be a region of the spectral purity filter 60 onto which, in use, a radiation beam (and/or an intensity distribution of radiation having a first and/or second wavelength) is to be centered. Again, the second region 66 may be a region of the spectral purity filter 60 which surrounds the first region 64.

Apertures 68 are provided in the spectral purity filter, and these apertures 68 extend through the members 65 of the spectral purity filter 60. Each aperture 68 is arranged to suppress (e.g. by diffraction) radiation having a first wavelength (for example, undesirable radiation such as infrared radiation) and to allow at least a portion of radiation having a second wavelength (such as, for example, EUV radiation) to be transmitted through the aperture 68. This can be achieved by choosing an aperture diameter which is similar to the first wavelength of radiation (e.g. the same order of magnitude) and which is greater than the second wavelength of radiation (e.g. twice as large, or an order of magnitude larger). The second wavelength of radiation is shorter than the first wavelength of radiation.

The first region 64 of the spectral purity filter has a first configuration that results in a first radiation transmission profile for the radiation having the first wavelength and the radiation having the second wavelength that is incident on that first region 64. The second region 66 of the spectral purity filter 60 has a second, different configuration that results in a second, different radiation transmission profile for the radiation having the first wavelength and the radiation having the second wavelength that is incident on that second region 66. A location or a dimension (e.g. an extent, shape or area) of the first region 64 and/or of the second region 66, and/or the first configuration and/or the second configuration, is related to at least one of: an angle of incidence of at least a part of a beam of radiation comprising radiation having the first wavelength and/or the radiation having the second wavelength that, in use, is to be incident upon (i.e. directed towards) the spectral purity filter; and/or an intensity distribution of at least a part of beam of radiation comprising the radiation having the first wavelength and/or the radiation having the second wavelength that, in use, is to be incident upon (i.e. directed towards) the spectral purity filter. The intensity distribution may be specifically for one or both of the radiation having the first wavelength, and the radiation having the second wavelength that together constitute the beam of radiation.

The configurations (or differences in those configurations) may be one or more of: a shape of one or more apertures of the spectral purity filter, a diameter of one or more apertures, a depth of one or more apertures, a space between one or more apertures a degree of tapering of one or more apertures, an angle of inclination of one or more apertures (i.e. the angle at which the aperture extends through the spectral purity filter with respect to a normal of a plane defined by that spectral purity filter), a position of one or more apertures (e.g. the location, distribution, spacing, or density of apertures), a thickness or depth of a spectral purity filter, and/or a material of a spectral purity filter (for example a material that is transmissive or opaque to, for example, radiation having the first or second wavelength). Any one or more of these can be configured to change the transmission profile for the specific region of the spectral purity filter, to, for example, ensure that more radiation having a second wavelength is transmitted through that region of the spectral purity filter (in comparison with a spectral purity filter having only a single distinct region with a single configuration), while still suppressing radiation having the first wavelength to or within certain limits.

Referring back to the embodiment of FIG. 6, the configuration of the first region 64 of the spectral purity filter 60 is different from the configuration of the second region 66 of the spectral purity filter 60. The configuration is different in that the first region 64 of the spectral purity filter 60 has a first depth 70 that is greater than a second depth 72 of the second region 66. The reduced depth 72 of the second region 66 allows more radiation having the second wavelength that is incident on the second region 66 of the spectral purity filter 60, and at an angle to a normal to a plane defined by the filter 60, to be transmitted through the second region 66. This is because less radiation can be and will be absorbed or scattered by sidewalls 73 of the apertures 68, since the sidewalls are shorter (i.e. because the apertures 68 are not as deep).

Radiation having a first wavelength 74 (e.g. infrared radiation) and radiation having a second wavelength 76 (e.g. EUV radiation) is directed towards the spectral purity filter 60. The radiation 74, 76 may, for example, constitute a non-parallel (i.e. a convergent or divergent) beam of radiation. If the beam of radiation is centered along the centerline 62 of the spectral purity filter 60, the angle of incidence of radiation 74, 76 incident on the second region 66 (i.e. an outer region) of the spectral purity filter 60 will be greater (with respect to a normal of the plane defined by the spectral purity filter 60) than radiation 74, 76 that is incident on the first region 64 (i.e. a central region) of the spectral purity filter 60.

For the first region 64 of the spectral purity filter 60, radiation having a first wavelength 74 and radiation having a second wavelength 76 is incident upon the spectral purity filter 60 in a direction which is substantially perpendicular to a plane defined by the spectral purity filter 60. The radiation having the first wavelength 74 is diffracted by the apertures 68 and is substantially suppressed from being transmitted through the spectral purity filter 60. Only a small percentage of radiation having the first wavelength 74 is transmitted through the aperture 68 of the spectral purity filter. Radiation having the second wavelength 76 readily passes through the aperture 68 of a spectral purity filter 60. This is because the radiation having the second wavelength 76 is not substantially diffracted and suppressed by the aperture 68. Less radiation having the second wavelength 76 can be and will be absorbed or scattered by sidewalls 73 of the apertures 68, since the sidewalls are shorter (i.e. because the apertures 68 are not as deep).

Referring back to FIG. 5, when radiation is incident on the spectral purity filter 40 at an angle to a normal defined by a plane defined by the spectral purity filter 40, there is a risk that radiation having the second wavelength 52 (and which is not diffracted by the apertures 44 of the spectral purity filter 40) may be incident on and absorbed or scattered by side walls 54 of the apertures 44. Such absorption or scattering prevents the radiation having the second wavelength 52 from being transmitted through the spectral purity filter 40. According to an embodiment of the present invention, this potential problem may be overcome by reducing the depth of the spectral purity filter 40 and thus the depth of the apertures 44. This reduction is depicted in FIG. 6.

Referring back to FIG. 6, the second region 66 of the spectral purity filter 60 has a reduced depth 72 in comparison with the depth 70 of the first region 64 of the spectral purity filter. Thus, radiation having a second wavelength 76 and which is incident at an angle to the second wavelength 66 of the spectral purity filter may be transmitted through the spectral purity filter due to the reduction in depth 72. At the same time, the reduction in depth may not significantly affect the suppression by diffraction of radiation having the first wavelength 74. Thus, for the second region 66 of the spectral purity filter 60, the transmission of radiation having the second wavelength 76 is increased in comparison with, for example, an outer region of a spectral purity filter which has the same depth as the inner region of the spectral purity filter, while at the same time still managing to suppress the radiation having the first wavelength 74. Even if the suppression of radiation having the first wavelength 74 is reduced, this reduction may still fall within predetermined limits, while still allowing for the transmission of radiation having the second wavelength 76 to be increased.

Although FIG. 6 schematically depicts the reduction in depth of the second region 66, other configurations or change in configurations are possible to achieve a similar or substantially the same effect. For instance, instead of, or as well as reducing the depth of the second region 66 of the spectral purity filter 60, the apertures 68 in the second region 66 may have a greater diameter than apertures 68 in the first region 64 of the spectral purity filter 60.

As discussed above, a location or dimension (e.g. an extend or area) of the first region or the second region of the spectral purity filter may be related to an angle of incidence of radiation on the first or second part of the spectral purity filter, and/or intensity distribution of that radiation. This may be exemplified using FIG. 7.

FIG. 7 schematically depicts a spectral purity filter 80. The spectral purity filter comprises of a first inner region 82 and a second outer region 84 which surrounds the first inner region 82. The inner region 82 is substantially circular in shape, and the second outer region 84 is substantially annular in shape.

Radiation having a first wavelength and radiation having a second wavelength may, in use, be directed towards and be incident upon the spectral purity filter 80. The intensity distributions of the radiation having the first wavelength and radiation having the second wavelength may be substantially the same. In this case, a differentiation can be achieved by taking advantage of the angular dependence of the transmission of radiation of the first wavelength and of the second wavelength through the spectral purity filter. For instance, and as discussed above, the suppression of radiation having the first wavelength by diffraction is substantially independent of the angle of incidence of that radiation (for small incidence angles). Conversely, the transmission of radiation having a second wavelength that is not diffracted by the apertures is dependent on the angle of incidence of radiation on the spectral purity filter.

If, for example, the spacing or apertures in the first region 82 is different from the spacing of apertures in the second region 84 (i.e. the difference in configurations of the first and second regions 82, 84 is a difference in the spacing or location of apertures), the transmission of radiation through those apertures may be different for both regions 82, 84. For example, the first region 82 may transmit substantially 0% of radiation having the first wavelength. The second region 84 may transmit substantially 4% of radiation having the first wavelength. These transmission percentages are, as discussed above, substantially independent of the angular of incidence of the radiation incident on those regions 82, 84. Conversely, radiation having the second wavelength will be transmitted more readily through the second region 84 than it would if the configuration of the second region 84 was the same as the configuration of the first region 82, because the apertures in that second region 84 region are more closely packed. Thus, the overall transmittance of the spectral purity filter will depend on the relative extend (e.g. sizes) of the first region 82 and the second region 84. For example, in order to obtain an overall transmission percentage of the first wavelength of radiation of 1%, the transition between the two regions 82, 84 should be located at a radius R of 0.8 Rₘₐₓ, where Rₘₐₓ is the maximum radius of the spectral purity filter 80 (and thus of the second region 84 of the spectral purity filter). Such an arrangement will maintain the suppression of radiation having the first wavelength (e.g. infrared radiation) at or below a certain limit (in this case, 1%), while increasing the amount of radiation having the second wavelength (e.g. EUV radiation) that is transmitted through the spectral purity filter (for example, by a few percent).

In another example (not shown), the intensity distribution of radiation having the first wavelength and radiation having the second wavelength may not be equal to one another. In this case, the transition between the first region 82 and the second region 84 (and/or the location of those regions) can again be chosen to ensure that certain requirements are met, for example, the maximum transmission of radiation having the first wavelength.

In general, for any distribution of radiation having the first wavelength and radiation having the second wavelength, the configurations of the first region and second region are optimized with respect to those distributions such that a maximum effective transmission of radiation having the second wavelength is achieved while maintaining the suppression of radiation having the first wavelength at or below certain limits or specifications. For instance, in some beams of radiation, radiation having the first wavelength may be more uniformly distributed across the spectral purity filter than radiation having the second wavelength, which may for example peak near the centre of the spectral purity filter. In this case, it may be desirable to relax the suppression of radiation having the first wavelength near the centre of the spectral purity filter, thus maximizing the transmission of radiation having the second wavelength of radiation through the spectral purity filter, because the ratio of second to first wavelength of radiation is higher near the centre of the spectral purity filter.

Depending on the distributions of radiation having the first wavelength and radiation having the second wavelength, the dimensions (e.g. areas) of the first and second regions do not need to be circularly symmetric, but can also have other shapes.

The apertures of the spectral purity filter may have any appropriate shape. For example, the apertures may be circular (as is the case in the embodiments of FIGS. 6 and 7), or the apertures may be elongate (e.g. slit or slot like), hexagonal, square, elliptical, amongst other shapes. For instance, FIG. 8 schematically depicts a spectral purity filter 90 according to an embodiment of the present invention. A first, inner region 92 of the spectral purity filter 90 is provided with apertures 94 (which may have a hexagonal shape). Surrounding the first region 92 is a second, outer region 96 which comprises a plurality of slits apertures 98. The slit apertures 98 may be optimally aligned relative to a polarization direction of undesirable radiation, such as radiation having the first wavelength of radiation (e.g. infrared radiation).

In the above embodiments, first and second regions of the spectral purity filter have been described. In other embodiments, further regions can be provided, for example, third, fourth, fifth regions and the like. Each of these regions may have different configurations, to optimize the transmission of radiation having the second wavelength of radiation through the spectral purity filter, and/or at the same time maintaining the suppression of radiation having the first wavelength.

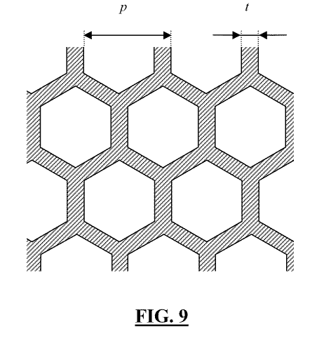

FIG. 9 is a more detailed view of hexagonally-shaped apertures, such as the apertures 94 of the inner region 92 of the spectral purity filter 90. Typically, a pitch p of these apertures may be about 5 μm and a distance t between two apertures may be about 0.5 μm. However, in the further region, the pitch p may be lower, for instance about 3 μm, in order to reduce infrared absorption. A distance t between two apertures may also be reduced to about 0.3 μm. Such a further region may be used at positions were a peak in spatial infrared distribution occurs.

In the embodiments described above, the first region and second region of the spectral purity filter, and the changes in the configuration between the first region and second region have been discrete (i.e. non-continuous) because the change in configuration was also discrete. In other embodiments, the configurations of the regions may vary continuously or gradually across one or more regions of the spectral purity filter. This may allow for full optimization of the configuration of one or more regions (e.g. relative to an incoming beam of radiation comprising first and/or second radius of radiation) at any position on the spectral purity filter. An additional potential advantage of this embodiment is that there will be no discrete steps in the transmission profile of the spectral purity filter, which may ease the requirements on illumination optics downstream of the spectral purity filter.

The spectral purity filter described above may be used in any suitable application. For instance, a lithographic apparatus (for example, the apparatus described above in relation to FIGS. 1 and/or 2) or a radiation source may be provided which incorporates one or more spectral purity filters as described above.

As described above, the spectral purity filters may be used to suppress radiation having a first wavelength of radiation, and allow the transmission of radiation having a second wavelength of radiation. The first wavelength of radiation may have a wavelength that is in the infrared part of the electromagnetic spectrum. For instance, the first wavelength of radiation may have a wavelength of 10.6 μm. The second wavelength of radiation may have a wavelength that is substantially equal to or shorter than radiation having a wavelength in the EUV part of the electrode electromagnetic spectrum. However, the spectral purity filter may be configured (i.e. the apertures may have dimensions) such that radiation having a different wavelength of radiation is diffracted and suppressed, and radiation having a different wavelength is allowed to be transmitted through the spectral purity filter. In the above described embodiments, a ‘desired’ (or ‘second’) wavelength of radiation has been described as being a wavelength of radiation in or below the EUV range of the electromagnetic spectrum. Furthermore, an ‘undesired’ (or ‘first’) wavelength of radiation has been described as a wavelength of radiation in the infrared part of the electromagnetic spectrum. It will be appreciated that the present invention is also applicable to other wavelengths of radiation that may be desired or undesired.

In the above embodiments, suppression by diffraction has been described. Suppression may also be attributable to scattering of the radiation at openings of the apertures, or within the apertures, or absorption of radiation by sidewalls of the apertures. In general, the apertures have dimensions arranged to suppress the radiation, which suppression may be by diffraction, scattering, reflection, absorption, or by any other means.

Although the above description of embodiments of the invention relates to a radiation source which generates EUV radiation (e.g. 5-20 nm), the invention may also be embodied in a radiation source which generates ‘beyond EUV’ radiation, that is radiation with a wavelength of less than 10 nm. Beyond EUV radiation may for example have a wavelength of 6.7 nm or 6.8 nm. A radiation source which generates beyond EUV radiation may operate in the same manner as the radiation sources described above. The invention is also applicable to lithographic apparatus that uses any wavelength of radiation where it is desired to separate, extract, filter, etc. one or more wavelengths of radiation from another one or more wavelengths of radiation. The described spectral purity filter may be used, for example, in a lithographic apparatus or a radiation source (which may be for a lithographic apparatus). The invention may also be applied to fields and apparatus used in fields other than lithography.

The description above is intended to be illustrative, not limiting. Thus, it will be apparent to one skilled in the art that modifications may be made to the invention as described without departing from the scope of the claims set out below.

What is claimed is:

1. A spectral purity filter, comprising:
a plurality of apertures extending through a member,
the apertures being arranged to suppress radiation having a first wavelength and to allow at least a portion of radiation having a second wavelength to be transmitted through the apertures, the second wavelength of radiation being shorter than the first wavelength of radiation,
wherein a first region of the spectral purity filter has a first configuration that results in a first radiation transmission profile for the radiation having the first wavelength and the radiation having the second wavelength, and a second region of the spectral purity filter has a second, different configuration that results in a second, different radiation transmission profile for the radiation having the first wavelength and the radiation having the second wavelength.

2. The spectral purity filter of claim 1, wherein a location or a dimension of the first region of the spectral purity filter, and/or a location or a dimension of the second region of the spectral purity filter is related to:
an angle of incidence of at least a part of a beam of radiation comprising radiation having the first wavelength and/or the radiation having the second wavelength that, in use, is to be incident upon the spectral purity filter; and/or
an intensity distribution of at least a part of a beam of radiation comprising the radiation having the first wavelength and/or the radiation having the second wavelength that, in use, is to be incident upon the spectral purity filter.

3. The spectral purity filter of claim 1, wherein the first region of the spectral purity filter having the first configuration is an inner region of the spectral purity filter, and wherein the second region of the spectral purity filter having the second configuration is an outer region of the spectral purity filter.

4. The spectral purity filter of claim 1, wherein the first region of the spectral purity filter having the first configuration is a region of the spectral purity filter onto which, in use a radiation beam is to be centered, and wherein the second region of the spectral purity filter having the second configuration is a region of the spectral purity filter that surrounds the first region.

5. The spectral purity filter of claim 1, wherein the first configuration and/or second configuration is related to at least one of:
an angle of incidence of at least a part of a beam of radiation comprising radiation having the first wavelength and/or the radiation having the second wavelength that, in use, is to be incident upon the spectral purity filter; and/or
an intensity distribution of at least a part of a beam of radiation comprising the radiation having the first wavelength and/or the radiation having the second wavelength that, in use, is to be incident upon the spectral purity filter.

6. The spectral purity filter of claim 1, wherein the first configuration, and/or the second configuration is one or more of:
a shape of one or more apertures;
a diameter of one or more apertures;
a space between one or more apertures;
a depth of one or more apertures;
a degree of tapering of one or more apertures;
an angle of inclination of one or more apertures;
a position of one or more apertures;
a thickness or depth of the spectral purity filter; and/or
a material of the spectral purity filter.

7. The spectral purity filter of claim 1, wherein the difference between the first configuration and the second configuration is one or more of:
a difference in a shape of one or more apertures;
a difference in a diameter of one or more apertures;
a difference in spacing between one or more apertures;
a difference in a depth of one or more apertures;
a difference in a degree of tapering of one or more apertures;
a difference in an angle of inclination of one or more apertures;
a difference in a position of one or more apertures;
a difference in a thickness or depth of the spectral purity filter; and/or
a difference in a material of the spectral purity filter.

8. The spectral purity filter of claim 1, wherein the first region of the spectral purity filter has a greater depth or thickness than the second region of the spectral purity filter.

9. The spectral purity filter of claim 1, wherein the second region of the spectral purity filter has apertures of a greater diameter than apertures in the first region of the spectral purity filter.

10. The spectral purity filter of claim 1, wherein the difference between the first radiation transmission profile and the second transmission profile is related to an amount of radiation of the first and/or second wavelength that is transmitted through the first and/or second region of the spectral purity filter.

11. The spectral purity filter of claim 1, wherein the first region of the spectral purity filter is formed integrally with the second region of the spectral purity filter.

12. The spectral purity filter of claim 1, wherein the first region of the spectral purity filter is formed separately from the second region of the spectral purity filter.

13. The spectral purity filter of claim 1, wherein the first wavelength of radiation has a wavelength that is in the infrared region of the electromagnetic spectrum.

14. The spectral purity filter of claim 1, wherein the second wavelength of radiation has a wavelength that is substantially equal to or shorter than radiation having a wavelength in the EUV part of the electromagnetic spectrum.

15. The spectral purity filter of claim 1, wherein the member is a plate.

16. The spectral purity filter of claim 1, wherein the member is a foil.

17. The spectral purity filter of claim 1, wherein the member is a membrane.

18. A lithographic apparatus, comprising:
a radiation source configured to generate radiation;
a spectral purity filter positioned in the radiation source and configured to filter the radiation generated by the radiation source, the spectral purity filter, comprising
a plurality of apertures extending through a member,
the apertures being arranged to suppress radiation having a first wavelength and to allow at least a portion of radiation having a second wavelength to be transmitted through the apertures, the second wavelength of radiation being shorter than the first wavelength of radiation,
wherein a first region of the spectral purity filter has a first configuration that results in a first radiation transmission profile for the radiation having the first wavelength and the radiation having the second wavelength, and a second region of the spectral purity filter has a second, different configuration that results in a second, different radiation transmission profile for the radiation having the first wavelength and the radiation having the second wavelength;
a support configured to support a patterning device, the patterning device being configured to pattern the radiation filtered by the spectral purity filter into a patterned beam of radiation; and
a projection system configured to project the patterned beam of radiation onto a substrate.

19. A radiation source configured to generate radiation, the radiation source comprising:
a spectral purity filter configured to filter the radiation generated by the radiation source, the spectral purity filter, comprising
a plurality of apertures extending through a member,
the apertures being arranged to suppress radiation having a first wavelength and to allow at least a portion of radiation having a second wavelength to be transmitted through the apertures, the second wavelength of radiation being shorter than the first wavelength of radiation,
wherein a first region of the spectral purity filter has a first configuration that results in a first radiation transmission profile for the radiation having the first wavelength and the radiation having the second wavelength, and a second region of the spectral purity filter has a second, different configuration that results in a second, different radiation transmission profile for the radiation having the first wavelength and the radiation having the second wavelength.
